(19) United States
(12) Patent Application Publication
(10) Pub. No.: US 2003/0067571 A1
(43) Pub. Date: Apr. 10, 2003

(54) Reflective cholesteric display with reduced viewing-angle color dependence

(75) Inventor: Anthony Cyril Lowe, Braishfield (GB)

Correspondence Address: International Business Machines Corporation, Personal and Printing Systems Group, Dept. 9CCA/Bldg. 002-2, P.O. Box 12195, Research Triangle Park, NC, 27709, US

(73) Assignee: International Business Machines Corporation, Armonk, NY (US)

(21) Appl. No.: 10/191,706

(22) Filed: Jul. 9, 2002

(30) Foreign Application Priority Data
Oct. 6, 2001 (GB) 0124069.6

(51) Int. Cl. G02F 1/1335

(52) U.S. Cl. 349/115

(57) ABSTRACT

A cholesteric liquid crystal display (LCD) having a reduced dependency between viewing angle and color is achieved by the addition of a weak diffuser to the front surface of the liquid crystal material. The diffuser diffuses both light incident on the surface of the liquid crystal material and light reflected from the liquid crystal material over a wide range of angles. Thus, at any one viewing angle a viewer will observe light that was incident on the display and reflected from it over a wide range of angles. As well as reducing the dependency between viewing angle and color, the addition of the diffuser broadens the range of wavelengths of light reflected by the LC material when it is in a reflective state.

### BACKGROUND OF THE INVENTION

1. Field of the Invention

The present invention relates to liquid crystal displays and more particularly to reflective cholesteric liquid crystal displays.

2. Description of the Related Art

Optical displays, such as liquid crystal displays (LCD), are widely used for laptop computers, hand-held calculators, digital watches, and the like. In a conventional LCD assembly, a liquid crystal panel with an electrode matrix is located between a front absorptive polarizer and a rear absorptive polarizer. In a LCD, portions of the liquid crystal have their optical state altered by the application of an electric field. This process generates the contrast necessary to display picture elements, or pixels, of information.

Typically the absorptive polarizers use dichroic dyes which absorb light of one polarization orientation more strongly than that of the orthogonal polarization orientation. In general, the transmission axis of the front polarizer is “crossed” with the transmission axis of the rear polarizer. The crossing angle can vary between zero and ninety degrees.

Optical displays can be generally classified based upon the source of illumination. Reflective displays are illuminated by ambient light that enters the display from the front. Typically a brushed aluminium reflector is placed behind the LCD assembly. This reflective surface returns light to the LCD assembly while preserving the polarization orientation of the light incident on the reflective surface. Backlit displays are illuminated by a backlight that is located behind the LCD assembly. The light from the backlight goes through a polarizer and reaches the LCD assembly where it is modulated to generate the pixels of information.

It has long been known that cholesteric LCDs can provide light modulation without recourse to polarizers and back lighting by using Bragg scattering from the periodic chiral structure of the LCD. This light modulation capability arises from the ability of cholesteric liquid crystals to exist in either a reflective or in a light scattering structure. In the light scattering or dark state, the liquid crystal molecules are arranged in domains with the long axes of the molecules roughly parallel to each other in each hypothetical layer. When an electric field is applied across the liquid crystal there is a progressive slight displacement of the long axis of the molecules in a layer with respect to the adjacent layer. The combined net effect of these small displacements is the creation of a helical molecular structure in each domain of the liquid crystal. When the helical axes are roughly parallel to each other and perpendicular to the cell surface, light perpendicularly incident on the LCD cell surface is efficiently transmitted except for a relatively narrow wavelength band which is reflected. The wavelength of the reflected light is given by the relationship lambda k=nₐP where nₐ is the average refractive index of the liquid crystal and P is the pitch (that is twice the repetition length of the helical structure) of the liquid crystals. The reflected wavelength maximum is selectable by appropriate adjustment of the nₐ and/or P values of the liquid crystal mixes employed. This is referred to as the Reflective State.

If light of a wavelength other than the selected wavelength is incident upon the reflective cholesteric liquid crystal display, then it is scattered. The scattering occurs because of the two dimensional random orientation of the helical axis of the domains. This randomisation provides an efficient scattering of incident light.

Cholesteric displays are always colored and as the angle of view of the display changes, the effective pitch of the LCD varies as the cosine of the refracted angle within the LCD. Thus the wavelength of the reflected light decreases as the viewing angle increases from the display normal. Green displays turn blue and yellow ones turn green.

As such, it would be desirable to provide a cholesteric liquid crystal display which had a reduced dependency between the viewing angle and the color of the display.

### SUMMARY OF THE INVENTION

Accordingly, the present invention provides a cholesteric liquid crystal display having a reduced dependency between viewing angle and color, comprising: a layer of cholesteric liquid crystal having a transmissive state and a reflective state, incident light of a wavelength k substantially equal to the average refractive index nₐ multiplied by the pitch P of the helices in the liquid crystal, being reflected in the reflective state, incident light of wavelengths other than wavelength k being substantially transmitted; a layer for absorbing light incident thereupon, located in contact with a first surface of the liquid crystal display characterised in that the cholesteric liquid crystal display further comprises: a diffuser located in contact with a second surface of the liquid crystal display, the first and second surfaces being opposing surfaces, the helices of the liquid crystal being arranged in a direction perpendicular to the first and second surfaces.

The addition of a weak diffuser means that both light incident on the display and reflected from the display is diffused over a range of angles. This has the advantage of reducing the dependency of the color to the angle of view of the display. Additionally, the range of wave lengths reflected by the display is increased.

Preferably, the diffuser is a surface relief holographic diffuser, as such a diffuser has a very low percentage backscatter which has the added advantage of maintaining the contrast ratio of the reflective display.

### BRIEF DESCRIPTION OF THE DRAWINGS

Other aspects, features, and advantages of the present invention will become more fully apparent from the following detailed description, the appended claims, and the accompanying drawings, in which:

FIG. 1 is a schematic diagram of a prior art cholesteric display;

FIG. 2 is a graph showing the diffuse backscatter of a diffuser suitable for use in a preferred embodiment of the present invention plotted against the refractive index of the immersion medium; and

FIG. 3 shows a scanning electron microscope image of the surface profile of a diffuser suitable for use in the present invention.

### DETAILED DESCRIPTION

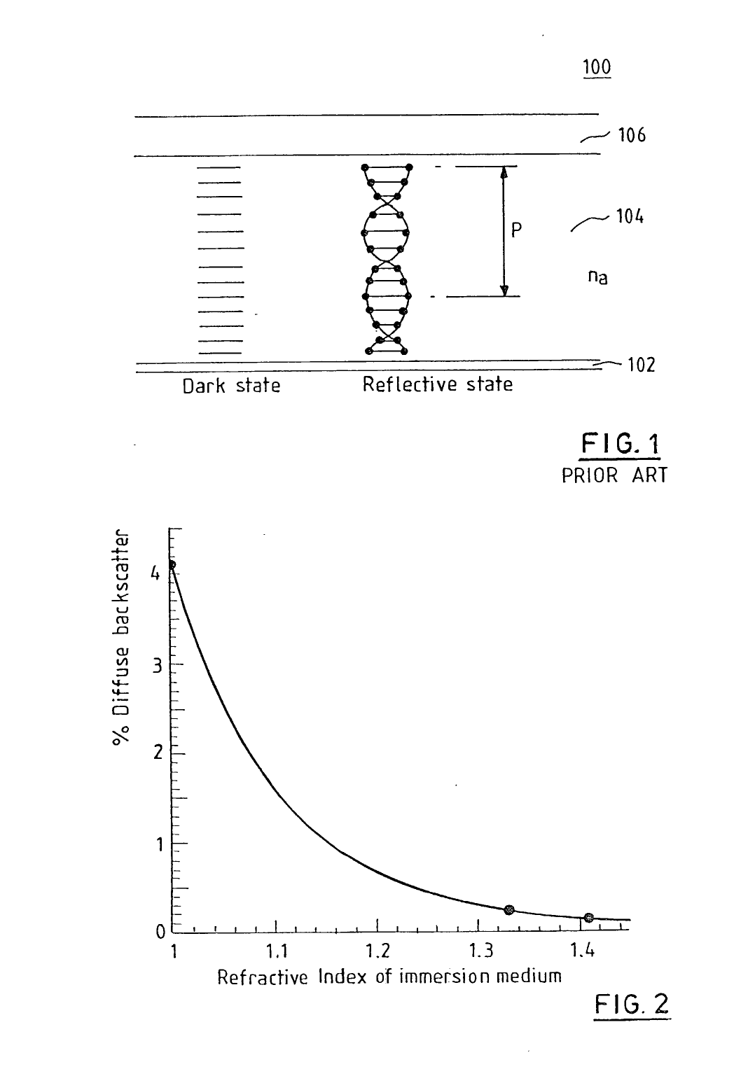

FIG. 1 is a schematic diagram of a prior art cholesteric display. FIG. 1 shows a cholesteric display 100 comprising a backplate liner 102 which can strongly absorb light which is incident upon it. Light which reaches the backplate liner 102 has first passed through a layer 104 of cholesteric liquid crystal having a refractive index nₐ that is preferably between 1.3 and 1.5 and more preferably approximately 1.4, although other refractive indices may be used with the present invention.

The cholesteric liquid crystal has molecules which by application of an electric field can be arranged in a helical structure having a pitch P which is twice the repetition length of the helical structure. As described earlier, this means that light of wavelengths other than that corresponding to k=nₐP is scattered and ultimately absorbed by backplate liner 102. Light of wavelength k=nₐP is reflected by the helical structure and the areas of the liquid crystal exhibiting the helical structure appear to be the color of the light of wavelength k. For example, if the liquid crystal structure is arranged such that the nₐ and P are chosen to give a wavelength k upon corresponding to the wavelength of yellow light, then those pixels of the liquid crystal which have an electric field applied and so are in the reflective state will appear yellow. When no electric field is applied to a pixel of the cholesteric display, the molecules act to scatter light of all wavelenths. The scattered light is ultimately absorbed by backplate liner 102. Those pixels having no electric field applied are in the transmissive state and will appear black.

When a cholesteric display is viewed from other than directly in front, the light reaching the viewer has been reflected from the helices of the liquid crystal material at an angle rather than straight on from along the major axis of the helix. The effective pitch of the helix is reduced by a factor corresponding to the cosine of the refracted angle within the liquid crystal. Since the effective pitch is reduced, the wavelength of light which is reflected is reduced. This results in the color of the display changing. For example, a display which has the refractive index and pitch chosen so as to appear yellow when viewed straight on appears green when viewed at an angle and a display that has the refractive index and pitch chosen so as to appear green when viewed straight on appears blue when viewed at an angle.

The present invention adds a weak diffuser 106 to the front surface of the display, so that both light incident on the display and light reflected from the display is diffused over a range of angles. Thus, at any one viewing angle, the viewer will observe light that was incident on the display and reflected from it over a range of angles. So, as the viewing angle of the viewer varies, the light observed will continue to be incident upon and reflected over a wide range of angles and thus remain unchanged in color. Additionally, the observed light will be of a broader range of wavelengths. Reducing the angle-dependent change of wavelength and hence color and broadening the wavelength range of the reflected light are both desirable characteristics.

The diffuser 106 should preferably have a low backscatter, since backscattered light significantly reduces the contrast of reflective displays. A suitable diffuser for use in the present invention is a surface relief holographic diffuser. Such diffusers scatter efficiently at all visible wavelengths and their backscatter is lower than other types of diffuser.

FIG. 2 is a graph showing the diffuse backscatter of a diffuser suitable for use in a preferred embodiment of the present invention plotted against the refractive index of the immersion medium. FIG. 2 shows a plot of the percentage backscatter versus the refractive index of the immersion medium (in this case the liquid crystal material). The typical refractive index of a cholesteric liquid crystal is about 1.4, so that a backscatter of about 0.15% can be achieved. Other refractive indices may be used with corresponding changes in backscatter percentage.

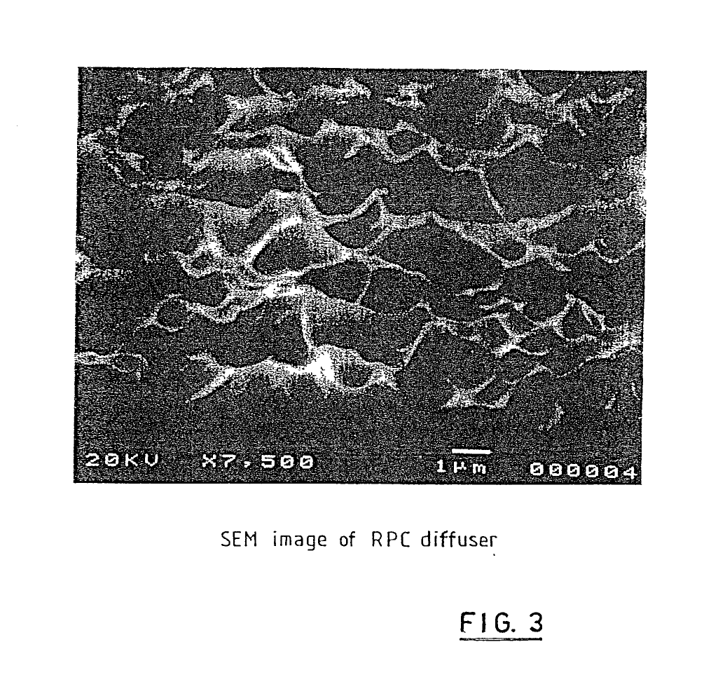

FIG. 3 shows a scanning electron microscope image of the surface profile of a diffuser suitable for use in the present invention. More particularly, FIG. 3 shows the surface profile of a surface relief holographic diffuser. The scale line of 1 lm at the lower part of the photograph indicates the typical size of the structures on the surface of the diffuser. Other diffusers may be used on surface relief holographic diffusers having different feature sizes may be used in the present invention. The most suitable diffusers have a low percentage backscatter.

1. A cholesteric liquid crystal display having a reduced dependency between viewing angle and color, comprising:
a layer of cholesteric liquid crystal having a transmissive state and a reflective state, incident light of a wavelength k substantially equal to the average refractive index nₐ multiplied by the pitch P of the helices in the liquid crystal, being reflected in the reflective state, incident light of wavelengths other than wavelength k being substantially transmitted; and
a layer for absorbing light incident thereupon, located in contact with a first surface of the liquid crystal display;
wherein the cholesteric liquid crystal display further comprises:
a diffuser (106) located in contact with a second surface of the liquid crystal display, the first and second surfaces being opposing surfaces, the helices of the liquid crystal being arranged in a direction perpendicular to the first and second surfaces.

2. The display of claim 1, wherein the diffuser has a backscatter of less than 1%.

3. The display of claim 2, wherein the diffuser has a backscatter of between 0.1% and 0.2%.

4. The display of claim 3 wherein the diffuser is a surface relief holographic diffuser.

5. The display of claim 4 wherein the cholesteric liquid crystal has a refractive index of between 1.3 and 1.5.

6. The display of claim 1, wherein the diffuser is a surface diffuser, the cholesteric liquid crystal has a refractive index of between 1.3 and 1.5, and the diffuser has a backscatter of between 0.1% and 0.2%.
